(19) United States
(12) Patent Application Publication
(10) Pub. No.: US 2003/0015029 A1
(43) Pub. Date: Jan. 23, 2003

(54) System and method for fault detection in the course of influencing the handling characteristics of a vehicle

(76) Inventors: Walter Berger, Erligheim (DE); Thomas Botzian, Ludwigsburg (DE)

Correspondence Address: KENYON & KENYON, ONE BROADWAY, NEW YORK, NY, 10004, US

(21) Appl. No.: 10/173,265

(22) Filed: Jun. 17, 2002

(30) Foreign Application Priority Data
Jun. 15, 2001 (DE) 101 29 076.4

(51) Int. Cl. G01L 5/28

(52) U.S. Cl. 73/121

(57) ABSTRACT

A system is provided for detecting faults occurring in the course of influencing the handling characteristics of a vehicle having at least two brake circuits, at least one return pump for each brake circuit and an arrangement for detecting the fault, the arrangement for detecting the fault including wheel-speed sensors and an evaluation unit, a fault being detectable by comparing the speeds of wheels allocated to different brake circuits. Furthermore, a method is described for detecting a fault occurring in the course of influencing the handling characteristics of a vehicle.

### FIELD OF THE INVENTION

The present invention relates to a system for detecting faults occurring in the course of influencing the handling characteristics of a vehicle, having at least two brake circuits, at least one return pump for each brake circuit, and an arrangement for detecting the fault. Furthermore, the present invention relates to a method for detecting faults occurring in the course of influencing the handling characteristics of a vehicle, having at least two brake circuits and at least one return pump per brake circuit.

### BACKGROUND INFORMATION

Known systems exist for monitoring and influencing the handling characteristics of a vehicle. Closed-loop controls as well as open-loop controls may be used within the framework of such systems. Conventional systems for controlling the operating dynamics may include the antilock braking system (ABS), traction control system (TCS) and the electronic stability program (ESP). Such systems may be particularly useful in borderline situations where they supply improved stability and steerability of the vehicle.

In ABS, the handling characteristics of the vehicle may be improved by reducing or eliminating the lock-up tendency of the wheels. This may be accomplished by blocking the brake line between a master brake cylinder and a wheel cylinder or a wheel brake cylinder. A return pump may then reduce the pressure in the wheel brake cylinder by returning the brake fluid to the master brake cylinder. It may also be possible, for instance in a TCS or some other ESP control system, to increase the pressure in the wheel brake cylinder via the pump.

A break-down of the system for influencing the handling characteristics may be problematic not only in view of driving comfort, but also with regard to driving safety. Therefore, it may make sense to detect such a system failure and to take it into account. According to the related art, the improper functioning of the return pump or pump motor may be detected via the check-back indication of the pump motor after-run. However, there may be circumstances when such monitoring may not always yield reliable results, since mechanical faults of the pump, such as a break-down of the pump element or the intake and discharge valves, may result in an insufficient delivery rate, although these faults may not be detectable from the check-back indication of the pump motor after-run, since the latter may still be taking place. Failure to detect such a system malfunction may cause the wheels to lock up, for instance, and thus result in impaired ABS/TCS/ESP function.

### SUMMARY OF THE INVENTION

The present invention provides a system in which an arrangement for fault detection includes wheel-speed sensors, the detection arrangement includes an evaluation unit, and a fault may be detectable by comparing the speeds of wheels assigned to different brake circuits. Wheel-speed sensors may already be present in the mentioned systems for influencing the handling characteristics of a vehicle. If the signals of these wheel-speed sensors are evaluated in an evaluation unit and the speeds of the wheels are compared, a fault in the system may thereby be inferred. The fault detection implemented in this manner may be based on the feature that it may be highly unlikely that a fault will occur in both brake circuits simultaneously. Therefore, a faulty operation of one of the brake circuits may in all likelihood result in different speeds of the wheels allocated to the different brake circuits, so that an error may be detected in this manner.

The system according to the present invention may be refined such that an error may be generally detected in an antilock system if at least one wheel of a wheel circuit locks up and the wheels of the other wheel circuit do not. In this case, for instance, a faulty brake circuit in an antilock braking system may be unable to remove the brake pressure from the wheel brake cylinder with the aid of a properly functioning pump, and the wheels therefore lock up. If it is detected at the same time that the wheels of the other brake circuit do not lock up, this may be taken as an indication that the particular brake circuit is faulty.

The signals from the wheel-speed sensors may be filtered over time, so that road influences may be eliminated. Such road influences may include, for instance, rugged road surfaces, low coefficients of friction, a μ jump etc. Because of their characteristic effects on the properties of the wheel speed over time, the evaluation unit may eliminate such road influences.

In a similar manner, it may be possible to filter the signals of the wheel-speed sensors over time, so that vehicle influences may be eliminated. Drag torque, a pulled handbrake, low vehicle speed, etc., may be examples of such vehicle influences. These influences may also cause the wheels to lock up, e.g. individual wheels. Here, too, the time filtering, for example in a timing window of t=500 ms or as a function of the delay, may be used to eliminate the influences.

In an exemplary embodiment of the present invention, interferences may be eliminated by detecting additional signals. This may occur if a handbrake is pulled, for instance, which may cause the wheels to lock up, without the latter being caused by a faulty brake system.

It may be useful that the influencing of the handling characteristics is switched off after the fault has been detected, the fault is stored in a fault storage and/or a warning light comes on. The ABS/TCS/ESP systems mentioned as examples may be switched off immediately after a fault has occurred, or only after the end of control. Entering the fault in the fault storage may allow rapid detection of the fault. The vehicle driver may be warned by the warning light coming on.

The present invention provides a method wherein the wheel speeds are detected, the detected speeds are evaluated, and that a fault may be detected by comparing the speeds of the wheels allocated to different brake circuits. In this manner, the features of the present invention may be converted within the framework of a method. The wheel speed may be detected in most motor vehicles without special additional provisions. Given faulty operation of one of the brake circuits, different wheel speeds may most likely be detected for the wheels assigned to different brake circuits when the wheel speeds of different brake circuits are compared, so that a fault may be detected in this manner.

According to an exemplary method of the present invention, a fault may be generally detected in an antilock braking system if at least one wheel of a brake circuit locks up and the wheels of the other brake circuit do not. For instance, when using an antilock brake system, the locking of a wheel may result from a pump no longer being able to remove the brake pressure from the wheel brake cylinder. If the lock-up of one of the wheels is detected in a brake circuit, this may be used as an indication of a faulty brake circuit.

The signals from the wheel-speed sensors may be filtered over time, so that road influences may be eliminated, such as rough road surfaces, low coefficient of friction, a μ jump, etc. Since influences of this kind may cause different wheel-rotation behavior in the various brake circuits, these influences may need to be differentiated from a faulty brake system. The evaluation may effect such a differentiation based on the time characteristics of the wheel speeds.

In a similar manner, the signals of the wheel-speed sensors may be filtered over time, so that vehicle influences, such as drag torque, a pulled handbrake or a very low vehicle speed may be eliminated. Drag torque, a pulled handbrake or a very low vehicle speed may be examples of such vehicle influences.

According to an exemplary embodiment of the present invention, interferences may be eliminated by detecting additional signals. In the case of a pulled handbrake, for instance, this may occur by taking a handbrake signal into account.

It may be useful that the influencing of the handling characteristics is switched off after the fault has been detected, the fault is stored in a fault storage and/or a warning light comes on. Consequently, different measures may be taken after detecting a fault.

The present invention utilizes the finding that the speed sensor signals present in conventional ABS/TCS/ESP systems may be utilized to recognize faults in the system. This may be important because faults may occur even while using a return pump whose electric motor is working properly. Thus, the conventional check-back indication of the pump motor after-run as an unreliable criterion for a defective system may be replaced by a reliable evaluation through the present invention. Of course, it is within the framework of the present invention to use the pump motor after-run as a further criterion, in addition to the evaluation of the speed sensor signals.

### BRIEF DESCRIPTION OF THE DRAWINGS

FIG. 1 shows a block diagram of an exemplary system according to the present invention.

FIG. 2 shows a flow chart of an exemplary method according to the present invention

### DETAILED DESCRIPTION

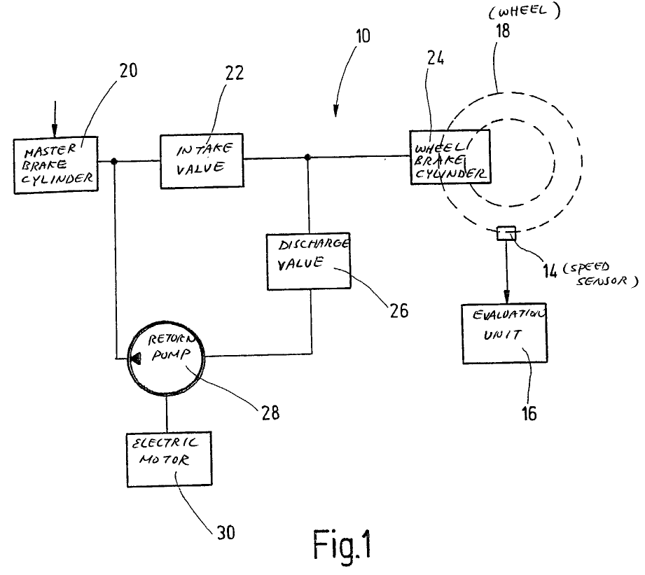

FIG. 1 shows a block diagram of an exemplary system according to the present invention. A master brake cylinder 20, operable by a brake pedal (not shown), is connected via an intake valve 22 to a wheel brake cylinder 24 allocated to a wheel 18. Wheel brake cylinder 24 is connected to a return pump 28 via a discharge valve 26. The return pump is able to return hydraulic fluid from wheel brake cylinder 24 to master brake cylinder 20 via discharge valve 26. Return pump 28 is powered by electric motor 30.

The motor after-run of electric motor 30 may be used to monitor the correct operation of the system.

However, since a brake circuit 10 may be faulty even if pump motor 30 is properly running on, the signals of speed sensors 14 allocated to wheel 18 may be evaluated in an evaluation unit 16. By comparing the speeds of wheels of different brake circuits 10, it may then be ascertained whether a fault has occurred in the system.

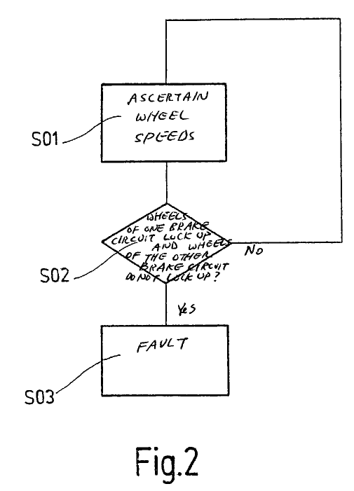

FIG. 2 shows a flow chart to illustrate an exemplary embodiment of a method according to the present invention. The method is described using the example of an antilock braking system. First, the meaning of the method steps represented in FIG. 2 is specified:

SO1: Wheel speeds are ascertained.

S02: Wheels of the one brake circuit lock up AND wheels of the other brake circuit do not lock up?

S03: Fault.

In step S01, the speeds of the individual wheels are ascertained.

In Step S02, it is ascertained whether the wheels of the one brake circuit lock up, while the wheels of the other brake circuit do not lock. Optionally, filter functions may be used to eliminate road influences or vehicle influences, respectively. If the question in Step S02 receives the answer No, no fault has occurred and the process continues without a fault message. However, if a fault has occurred, a fault is reported in Step S03. The system may then switch off, and the fault may be stored in a fault storage.

The preceding description of the exemplary embodiments according to the present invention is for illustrative purposes only, and is not meant to restrict the invention. Various changes and modifications may be possible within the framework of the present invention, without leaving the scope of the present invention and its equivalents.

What is claimed is:

1. A system for detecting a fault occurring in a course of influencing handling characteristics of a vehicle having a braking system including at least a first brake circuit and a second brake circuit, and at least one return pump for each brake circuit, comprising:
at least one wheel-speed sensor; and
an evaluation unit;
wherein a fault is detected by comparing detected speeds of wheels allocated to the at least first and second brake circuits.

2. The system according to claim 1, wherein the fault is detected in the braking system if at least one wheel of the first brake circuit locks up and wheels of the second brake circuit do not lock up.

3. The system according to claim 1, wherein signals of the at least one wheel-speed sensor are filtered over time to eliminate a road influence.

4. The system according to claim 1, wherein signals of the at least one wheel-speed sensor are filtered over a time to eliminate a vehicle influence.

5. The system according to claim 1, wherein an additional signal is detected to eliminate an interference.

6. The system according to claim 1, wherein the influencing of the handling characteristics is switched off after a fault has been detected, and wherein at least one of:
the fault is stored in a fault storage, and
a warning light is activated.

7. A method for detecting a fault occurring in a course of influencing handling characteristics of a vehicle having a braking system including at least a first brake circuit and a second brake circuit, and at least one return pump for each brake circuit, the method comprising:
detecting speeds of wheels allocated to the at least first and second brake circuits;
evaluating the detected speeds of wheels; and
comparing the detected speeds of wheels allocated to the at least first and second brake circuits.

8. The method according to claim 7, wherein a fault is detected in the braking system if at least one wheel of the first brake circuit locks up and wheels of the second brake circuit do not lock up.

9. The method according to claim 7, further comprising the step of:
filtering signals of a wheel-speed sensor over time to eliminate road-surface influences.

10. The method according to claim 7, further comprising the step of:
filtering signals of a wheel-speed sensor over time to eliminate vehicle influences.

11. The method according to claim 7, further comprising the step of:
detecting an additional signal to eliminate an interference.

12. The method according to claim 7, further comprising the steps of:
turning off the influencing of the handling characteristics after the fault has been detected; and
at least one of storing the fault in a fault storage and activating a warning light.
